(19) United States
(12) Patent Application Publication
(10) Pub. No.: US 2002/0112169 A1
(43) Pub. Date: Aug. 15, 2002

(54) System and method for providing telephone shopping service using originator telephone number and temporary password

(75) Inventor: Young-jin Hong, Kyungki-do (KR)

Correspondence Address: BURNS DOANE SWECKER & MATHIS L L P, POST OFFICE BOX 1404, ALEXANDRIA, VA, 22313-1404, US

(73) Assignee: Samsung Electronics Co., Ltd., Kyungki-do (KR)

(21) Appl. No.: 09/988,672

(22) Filed: Nov. 20, 2001

(30) Foreign Application Priority Data
Feb. 10, 2001 (KR) 2001-6622

(51) Int. Cl. H04L 9/00

(52) U.S. Cl. 713/184

(57) ABSTRACT

A method of providing a telephone shopping service in which a user is authenticated using an originator telephone number and a temporary password is provided. The method includes the steps of (a) receiving a temporary password and purchasing conditions from a user through telephone connection, (b) retrieving article information meeting the purchasing conditions received in step (a), after ending the telephone connection, (c) setting telephone connection to the user using the user s originator telephone number and confirming the user using the temporary password received in step (a), and (d) providing the article information retrieved in step (b) and arranging a transaction according to the user s selection. Accordingly, the method can provide a safe and convenience telephone shopping service by using a purchaser s originator telephone number and a temporary password. In other words, in a conventional telephone shopping method, a purchaser needs to register a purchaser ID and password for purchaser authentication in advance and memorize them. However, in this method, an originator telephone number is used as a purchaser ID, and a temporary password which is valid for only a single transaction is instantly created by a purchaser so that the identity of the purchaser can be confirmed using the temporary password.

Priority is claimed to Patent Application Set. No. 2001-6622, filed Feb. 10, 2001 in the Republic of Korea, herein incorporated by reference.

### BACKGROUND OF THE INVENTION

1. Field of the Invention

The present invention relates to a telephone shopping service, and more particularly, to a telephone shopping service in which a user is authenticated using an originator telephone number and a temporary password.

2. Description of the Related Art

FIG. 1 is a diagram of a typical telephone shopping method. For telephone shopping, as shown in FIG. 1, a user or purchaser 100 is connected to a telephone shopping mall (seller) 110 through a telephone network. Once the purchaser 100 accesses the telephone shopping mall 110, an Audio Reponse System 112 which receives a telephone inquiry and responds with a computer generated voice signal, or a telephone attendant 114 in the telephone shopping mall 110 responds. In addition, a separate billing server 116 for settling an account according to telephone shopping is usually provided for the telephone shopping mall 110.

In such a usual telephone shopping method, shopping time is from a point of time when the purchaser 100 calls the shopping mall 110 to a point of time when purchasing is completed. Here, it is inconvenient for the purchaser 100 to wait until articles meeting purchasing conditions are retrieved and purchasing is completed after accessing the telephone shopping mall 110. In other words, it is disadvantageous for the purchaser 100 to spend much time and pay for telephone charges for telephone shopping.

Moreover, in a conventional telephone shopping method, previously registered user information (ID, password, etc) or credit information is usually used for authenticating a user. Sometimes, it is required to input a user's credit card number for purchase. Accordingly, users suffer inconvenience of memorizing their user information. In addition, there are chances that fixed user information will be used unfavorably by others. Even if user information is input by users each time rather than relying on stored information, there is always a risk of an interception.

In a conventional telephone shopping method, a purchaser usually needs to know information (e.g., an article code number) on an article to purchase in advance. It is very troublesome for purchasers to memorize article information whenever making a purchase.

It is usual that each seller immediately bills purchasers through a separate billing server in a conventional telephone shopping method. Accordingly, purchasers need to perform settlement in different ways according to each seller's billing method. A telephone shopping mall also needs to be provided with a separate settlement device for credit cards.

### SUMMARY OF THE INVENTION

To solve the above-described problems, it is a first object of the present invention to provide a system and method for providing a telephone shopping service using a purchaser s originating telephone number and a temporary password so that the purchaser can safely and easily purchase an article meeting purchasing conditions within a short time.

It is a second object of the present invention to provide a system and method for providing a telephone shopping service using an originator telephone number and a temporary password, in which a user is authenticated using the originator telephone number and the temporary password and settlement for telephone shopping is performed by billing and payment of telephone charges.

To achieve the first object of the invention, in one aspect, there is provided a method of providing an on-line shopping service through a telephone network. The method includes the steps of (a) receiving a temporary password and purchasing conditions from a user through telephone connection; (b) retrieving article information meeting the purchasing conditions received in step (a), after ending the telephone connection; (c) setting telephone connection to the user using the user s originator telephone number and confirming the user using the temporary password received in step (a); and (d) providing the article information retrieved in step (b) and arranging a transaction according to the user s selection.

In another aspect, there is provided a method of providing an on-line shopping service through a telephone network, which includes the steps of (a) receiving a temporary password and purchasing conditions from a user through telephone connection; (b) retrieving article information meeting the purchasing conditions received in step (a), after ending the telephone connection; (c) setting telephone connection to the user using the user s originator telephone number and confirming the user using the temporary password received in step (a); (d) providing the article information retrieved in step (b) to the user through a telephone; and (e) requesting a telephone company billing server to bill a purchase charge as a telephone charge when a transaction is arranged according to the user s selection.

To achieve the second object of the invention, there is provided a system for providing an on-line shopping service, including a telephone network connector for interfacing with a user through a telephone network, a database for storing user information and article information, and a telephone shopping service processor for retrieving data from the database, storing data in the database, and processing a telephone shopping service request received from the user through the telephone network connector. The telephone shopping service processor receives a temporary password and purchasing conditions from the user through the telephone network connector, stores them in the database, retrieves article information meeting the purchasing conditions from the database after telephone connection to the user ends, sets telephone connection to the user through the telephone network connector using the user s originator telephone number when the retrieval of article information is completed, provides the retrieved article information to the user through the telephone network connector when the user is confirmed using the temporary password, and arranges a transaction according to the user s selection.

### BRIEF DESCRIPTION OF THE DRAWINGS

The above objects and advantages of the present invention will become more apparent by describing in detail preferred embodiments thereof with reference to the attached drawings in which:

FIG. 1 is a diagram of a typical telephone shopping method;

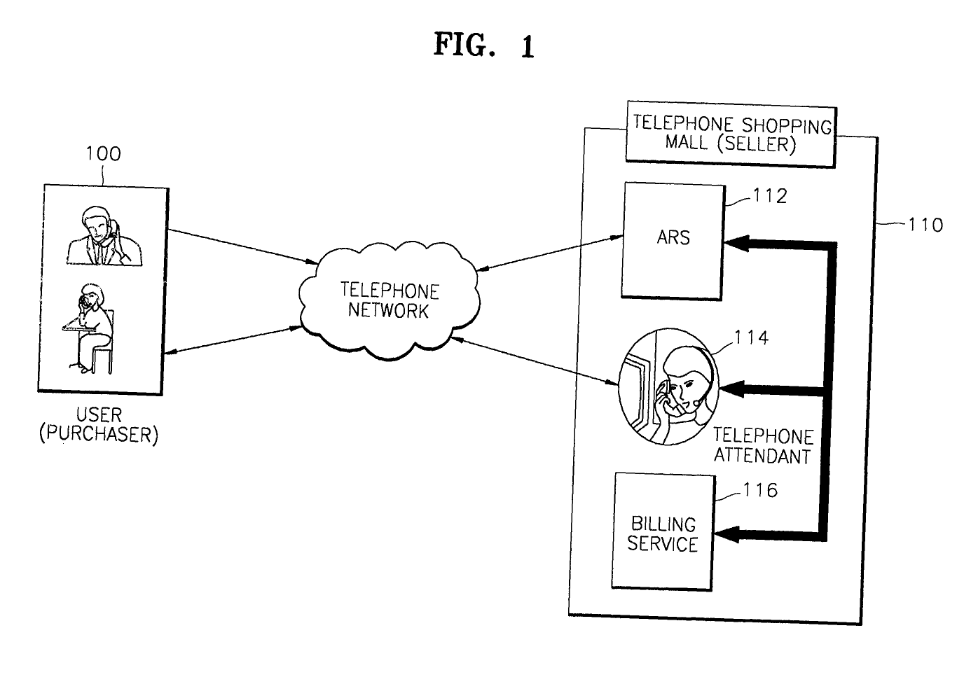

FIG. 2 is a schematic diagram of an example of the configuration of an entire system for providing a telephone shopping service according to an embodiment of the present invention;

FIG. 3A is an example flowchart of an interaction between a user (purchaser) and a telephone shopping mall server in a telephone shopping service according to the embodiment of the present invention;

FIG. 3B is an example flowchart of an interaction between a telephone shopping mall server and a seller in a telephone shopping service according to the embodiment of the present invention;

FIG. 3C is a schematic diagram of an example of information transmitted for settlement of a purchase charge through a telephone billing server in a telephone shopping service according to the embodiment of the present invention;

FIG. 4 is a diagram of an example of the mechanism of a telephone shopping service according to the embodiment of the present invention;

FIG. 5 is a schematic diagram of an example of the configuration of a telephone shopping mall server according to the embodiment of the present invention;

FIG. 6A is a flowchart of an example of a process of retrieving for article information in a telephone shopping mall server according to the embodiment of the present invention; and

FIG. 6B is a flowchart of an example of a process of selecting a seller from article information retrieved in a telephone shopping mall server according to the embodiment of the present invention.

### DETAILED DESCRIPTION OF THE INVENTION

Hereinafter, a preferred embodiment of the configuration and operation of the present invention will be described in detail with reference to the attached drawings.

The present invention provides a method of providing an easy and convenient telephone shopping service using an originator telephone number and a temporary password. In other words, when a purchaser calls a telephone shopping mall, the purchaser is identified with an originator telephone number automatically transmitted (or manually input), a temporary password used for a single transaction is generated, and the identity of the purchaser is confirmed through the temporary password, so that a purchase can be safely accomplished in telephone shopping.

In addition, in the present invention, once a user inputs purchasing conditions, a request process (i.e., telephone access) is terminated for a time. Thereafter, a telephone shopping mall retrieves articles meeting the purchase conditions, resets the telephone connection through an originator telephone number, and confirms the identity of the user through a temporary password before allowing the user to make a purchase.

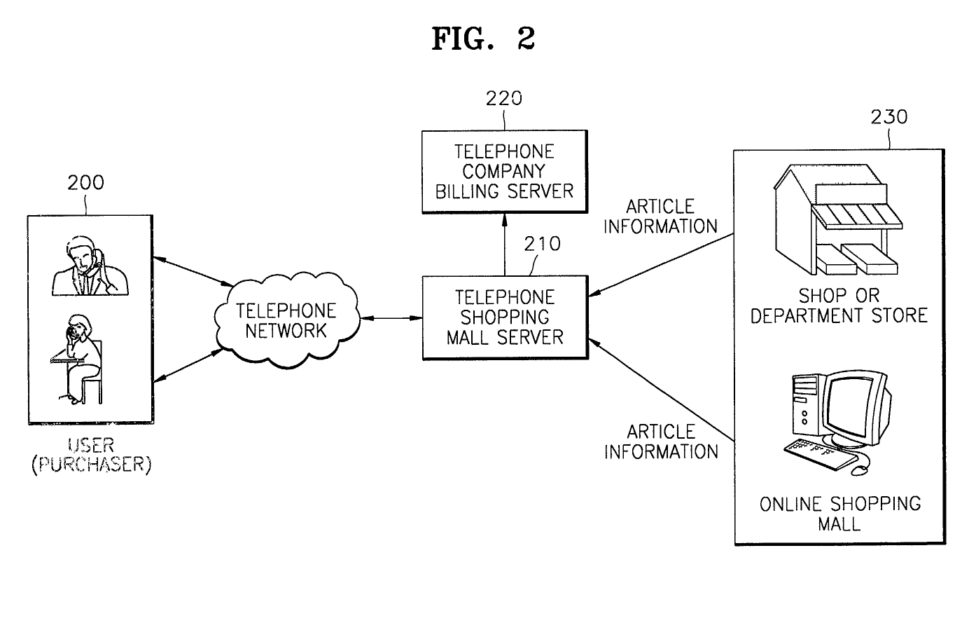

FIG. 2 a schematic diagram of an example of the configuration of an entire system for providing a telephone shopping service according to an embodiment of the present invention. As shown in FIG. 2, a system according to the embodiment of the present invention includes a user or purchaser 200, a telephone shopping mall server 210, and a seller 230 and selectively includes a telephone company billing server 220.

Briefly describing the operation of the present invention having the system configuration of FIG. 2, the user or purchaser 200 accesses the telephone shopping mall server 210 through a telephone network, inputs a temporary password and purchase conditions, and hangs up. Then, the telephone shopping mall server 210 retrieves articles meeting the purchase conditions, resets telephone connection to the purchaser 200, and confirms the identity of the purchaser 200 through the temporary password. Next, the telephone shopping mall server 210 provides retrieved article information to the purchaser 200 and arranges a transaction according to the selection of the purchaser 200.

Thereafter, the telephone shopping mall server 210 relays arranged transaction information to the actual seller 230, thereby acting as a purchase and sales agent. Here, the seller 230 may be an off-line shop or department store or an on-line shopping mall. The seller 230 provides article information necessary for building a database to the telephone shopping mall server 210.

For processing a charge for a purchase, preferably, the telephone shopping mall server 210 requests the telephone company billing server 220 to bill the purchase charge as a telephone charge, thereby providing a convenient payment method to the purchaser 200 and providing a reliable method of collecting the purchase charge to the seller 230.

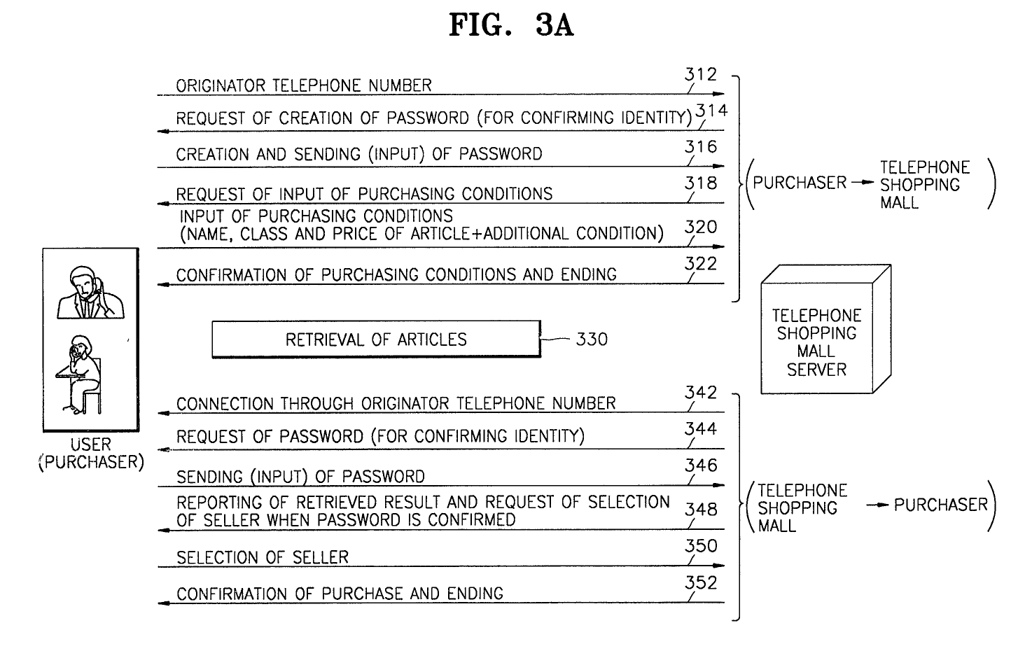

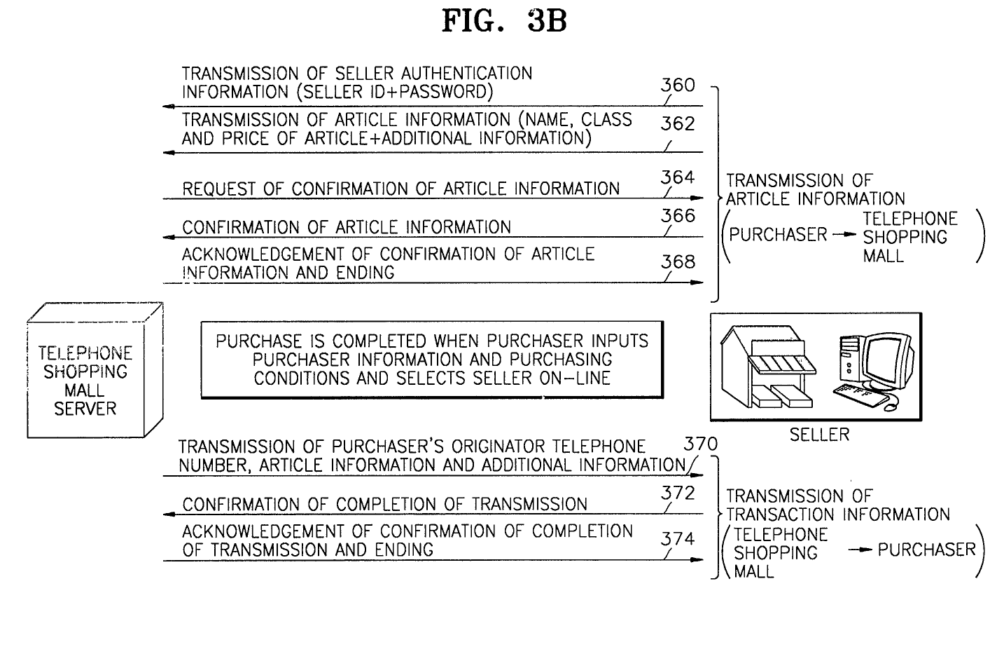

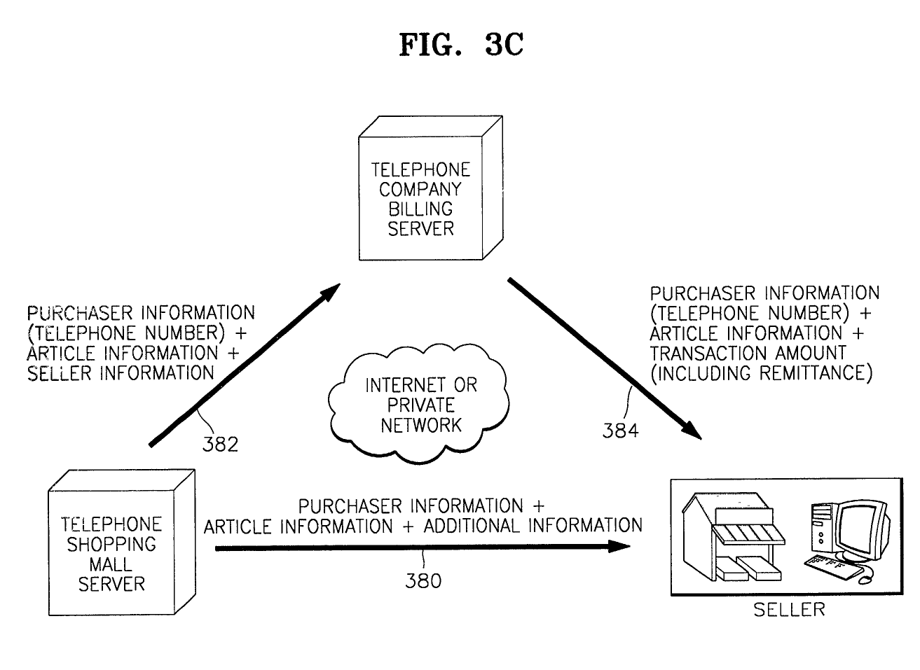

The following description with reference to FIGS. 3A through 3C concerns interface among the purchaser 200, the telephone shopping mall server 210, the seller 230 and the telephone company billing server 220. FIG. 3A is an example flowchart of an interaction between a user (purchaser) and a telephone shopping mall server in a telephone shopping service according to the embodiment of the present invention. In step 312, a user or purchaser accesses a telephone shopping mall through a telephone and provides an originator telephone number to a telephone shopping mall server. Here, the originator telephone number may be manually input by the user, but it is preferable that it is automatically sent by a telephone switching system during telephone connection.

Once the access is achieved, in step 314, the telephone shopping mall server requests creation of a password. Then, in step 316, the user creates and inputs a temporary password. Here, the temporary passwords is used for confirming the identity of the user.

Next, in step 318, the telephone shopping mall server requests input of purchasing conditions. Then, in step 320, the user inputs purchasing conditions including information such as the name, class and price of an article and an additional condition. Here, the article name and price must be input without fail.

Next, in step 322, the telephone shopping mall server confirms the purchasing conditions input by the user and ends the telephone connection. Here, it is preferable to confirm the purchasing conditions input in step 320 through speech output by using a text-to-speech technique of taking text at the input and generating speech at the output.

After ending the telephone connection, in step 330, the telephone shopping mall server retrieves article information, which meets the purchasing conditions input in step 320, from a database stored therein.

Next, in step 342, the telephone shopping mall server resets telephone connection through the originator telephone number input in step 312. In step 344, the telephone shopping mall server requests the user to input the temporary password to confirm the identity of the user. Once the user input the temporary password in step 346, the telephone shopping mall server compares the currently input temporary password with the temporary password input in step 316 to authenticate the user, reports the article information retrieved in step 330 to the user, and requests the user to select a seller, in step 348. Here, it is preferable to report the retrieved article information through speech output using a text-to-speech technique.

Next, once seller information selected by the user is input in step 350, the telephone shopping mall server allows the user to confirm the purchase and arranges a transaction, thereby ending the interface between the telephone shopping mall server and the user in step 352. Details about the transaction arranged in step 352 are provided to the selected seller. At the same time, it is preferable to request a telephone company billing server to bill a charge for the purchase as a telephone charge.

The interface between a telephone shopping mall server and a seller will be described below. FIG. 3B is an example flowchart of an interaction between a telephone shopping mall server and a seller in a telephone shopping service according to the embodiment of the present invention.

It is necessary for the telephone shopping mall server to build a database of article information in order to provide a telephone shopping service to users. For this, sellers provide article information to the telephone shopping mall server.

In step 360, a seller accesses the telephone shopping mall server and transmits seller authentication information including a seller ID and password to the telephone shopping mall server. If the seller is authenticated, in step 362, the seller transmits article information (the name, class, and price of an article, additional information, etc.) to the telephone shopping mall server. Next, in step 364, the telephone shopping mall server requests confirmation of the article information transmitted in step 362. Once the seller confirms the article information in step 366, the telephone shopping mall server acknowledges the confirmation of the article information and ends the connection in step 368.

The telephone shopping mall server builds a database with article information provided from sellers through steps 360 and 368. Thereafter, as described above, once receiving purchase information and purchasing conditions from a purchaser on-line, the telephone shopping mall server retrieves article information meeting the purchasing conditions from the database and provides the retrieved article information to the purchaser.

When a transaction is arranged, in step 370, the telephone shopping mall server provides the purchaser s originator telephone number, purchase article information and selective additional information to a seller selected by the purchaser. Then, the seller calls the purchaser through the originator telephone number, confirms purchasing content, and deliver a relevant article.

Thereafter, in step 372, the seller informs the telephone shopping mall server that the transmission (delivery) of the article is completed . Then, in step 374, the telephone shopping mall server acknowledges the confirmation of the completion of transmission (delivery), thereby ending the interface between the telephone shopping mall server and the seller.

Continuously, a process of settling payment through a telephone charge will be described. FIG. 3C is a schematic diagram of an example of information transmitted for settlement of a purchase charge through a telephone billing server in a telephone shopping service according to the embodiment of the present invention. Here, a telephone shopping mall server, a telephone company billing server, and a seller can be connected to one another through Internet or a private network.

For settling a purchase charge through a telephone charge, in step 382, the telephone shopping mall server requests the telephone company billing server to bill a purchaser for the purchase charge. The request includes purchaser information (e.g., a telephone number), article information and seller information. As described above, once a transaction is arranged, the purchaser information, the article information and additional information is provided to the seller in step 380.

Once receiving the request to bill the purchaser for the purchase charge, in step 384, the telephone company billing server bills a pertinent subscriber for the purchase charge as a telephone charge, transmits the purchaser information (including a telephone number), article information (including article name and price) and transaction amount information to the seller, and remits a transaction amount to the seller. Here, the seller may deliver an article to the purchaser before or after receiving the purchase charge from the telephone company billing server.

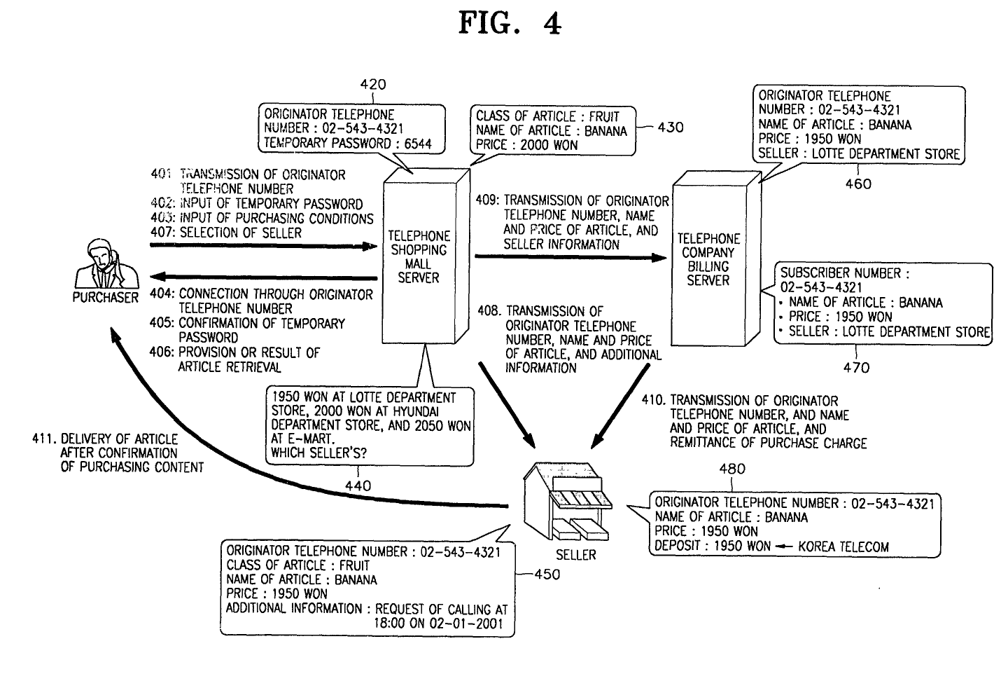

Next, the operation of the embodiment of the present invention will be described by explaining an example with reference to FIG. 4. FIG. 4 is a diagram of an example of the mechanism of a telephone shopping service according to the embodiment of the present invention.

In step 401, a purchaser accesses a telephone shopping mall server and transmits an originator telephone number. Thereafter, in step 402, the purchaser inputs a temporary password at the request of the telephone shopping mall server. In FIG. 4, Originator Telephone Number: 02-54304321, Temporary Password: 6544 exemplifies purchase information 420. Next, in step 403, the purchaser inputs purchasing conditions at the request of the telephone shopping mall server. In FIG. 4, Class of Article: Fruit, Name of Article: Banana, Price: 2000 Won exemplifies purchasing conditions 430.

After retrieving articles meeting the purchasing conditions 430, the telephone shopping mall server contacts the purchaser through the originator telephone number in step 404, and confirms the temporary password in step 405. Next, in step 406, the result of retrieving articles is provided through speech. In FIG. 4, 1950 Won at Lotte department store, 2000 Won at Hyundai department store, and 2050 Won at E-mart. Which seller s? exemplifies speech output 440. Once the purchaser selects a seller in step 407, the telephone shopping mall server confirms the selection and arranges a transaction.

After arranging the transaction, the telephone shopping mall server provides the originator telephone number, the name and price of the article, and additional information to a seller in step 408. In FIG. 4, Originator Telephone Number: 02-54304321, Class of Article: Fruit, Name of Article: Banana, Price: 1950 Won, Additional Information: Call at 18:00 01-02-2001 exemplifies purchasing information 450.

In step 409, the telephone shopping mall server provides the originator telephone number, the name and price of the article, and seller information to a telephone company billing server to request billing and payment of a purchase charge. In FIG. 4, Originator Telephone Number: 02-54304321, Name of Article: Banana, Price: 1950 Won, Seller: Lotte Department Store exemplifies billing and payment information 460.

Once receiving the request of billing and payment of a purchase charge, the telephone company billing server bills the purchase as a telephone charge on a subscriber number corresponding to the purchaser and expresses billing details on a bill. In FIG. 4, Subscriber Number: 02-543-4321, Name of Article: Banana, Price: 1950 Won, Seller: Lotte Department Store exemplifies the content 470 of expressing the billing details. In step 410, the telephone company billing server provides the originator telephone number and the name and price of article and remits the purchase charge to the seller. In FIG. 4, Originator Telephone Number: 02-54304321, Name of Article: Banana, Price: 1950 Won, Deposit: 1950 Won (Korea Telecom) exemplifies deposit information 480.

Once receiving transaction details from the telephone shopping mall server in step 408, the seller contacts the purchaser through the originator telephone number to confirm purchasing content and then delivers the article in step 411. As described above, the seller may deliver the article before or after the deposit of the purchase charge.

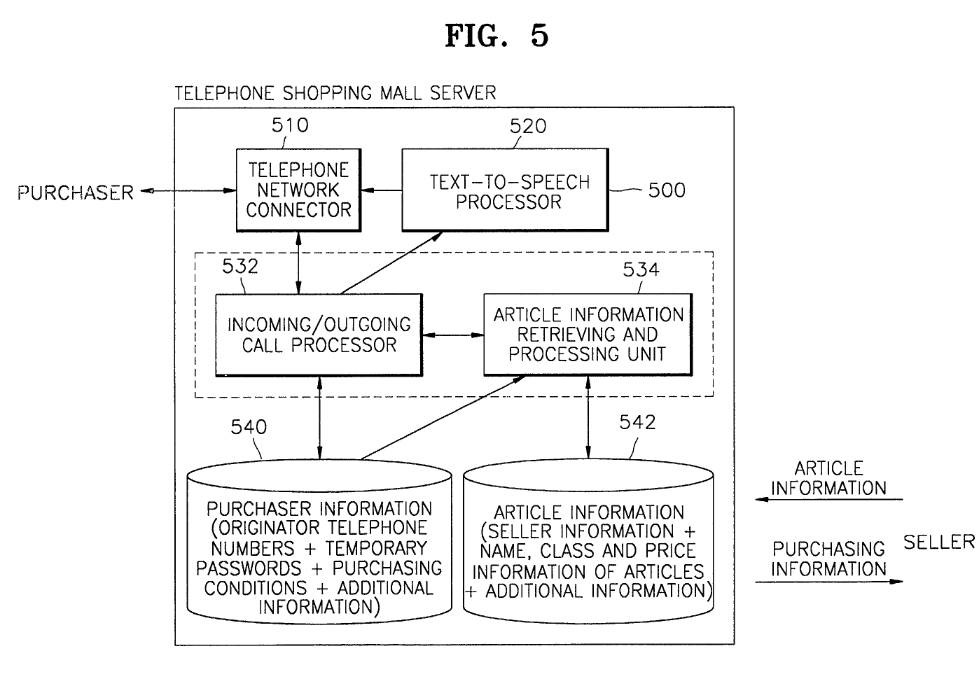

The internal configuration of a telephone shopping mall server according to the embodiment of the present invention will be described below with reference to FIG. 5. FIG. 5 is a schematic diagram of an example of the configuration of a telephone shopping mall server according to the embodiment of the present invention.

The telephone shopping mall server 500 includes a telephone network connector 510, a telephone shopping service processor 530, a purchaser information database 540 and an article information database 542, and selectively includes a text-to-speech processor 520.

The telephone network connector 510 interfaces with a purchaser through a telephone network. The purchaser information database 540 stores originator telephone numbers, temporary passwords, purchasing conditions and additional information. The article information database 542 stores seller information and the name, class and price information of articles. The text-to-speech processor 520 receives text and outputs speech corresponding to the text.

The telephone shopping service processor 530 performs data retrieval and data storing with respect to the purchaser information databases 540 and the article information database 542 and processes the purchaser s telephone shopping service request received through the telephone network connector 510. Here, the telephone shopping service processor 530 includes an incoming/outgoing call processor 532 for processing events occurring during telephone connection to the purchaser and an article information retrieving and processing unit 534 for performing retrieval according to purchasing conditions.

The telephone shopping service processor 530 receives a temporary password and purchasing conditions from the purchaser through the telephone network connector 510, stores them in the purchaser information database 540, and after ending the telephone connection, retrieves article information meeting the purchasing conditions from the article information database 542. Once completing the retrieval of article information, the telephone shopping service processor 530 sets telephone connection through the telephone network connector 510 using the purchaser s originator telephone number. Once the identity of the purchaser is confirmed through the temporary password, the telephone shopping service processor 530 provides the retrieved article information to the purchaser through the telephone network connector 510 and arranges a transaction at the selection of the purchaser.

Here, it is preferable that the retrieved article information is transmitted in the form of speech output to the telephone network connector 510 through the text-to-speech processor 520. The text-to-speech processor 520 transmits appropriate speech output to the telephone network connector 510 at the request of the telephone shopping service processor 530. For example, confirmation of the purchasing conditions received from the purchaser can be performed through speech output.

As described above, article information is received from a seller to build the article information database 542, and once a transaction is arranged, the details (purchasing information) of the arranged transaction are provided to a relevant seller. It is also preferable, as described above, to request a telephone company billing server to bill a purchase charge as a telephone charge once a transaction is arranged.

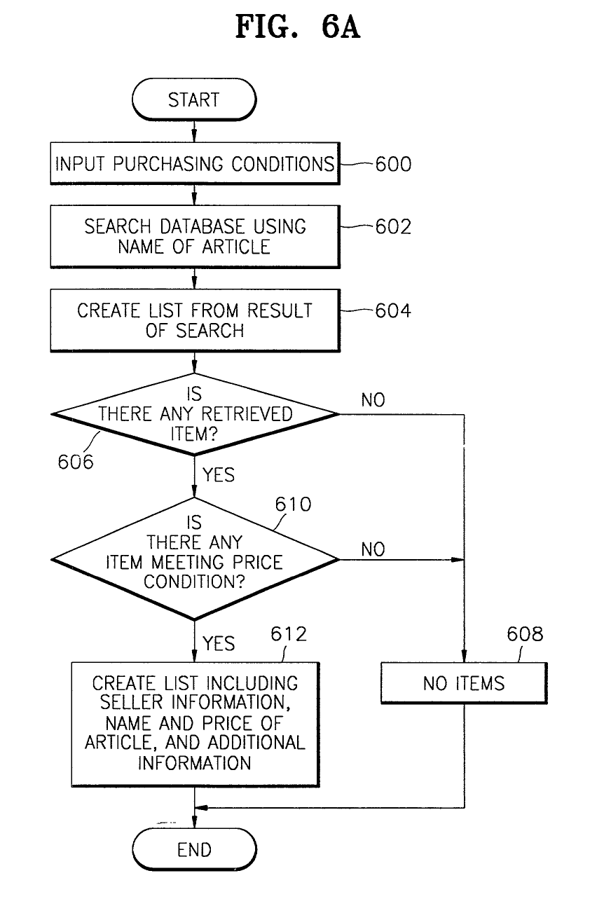

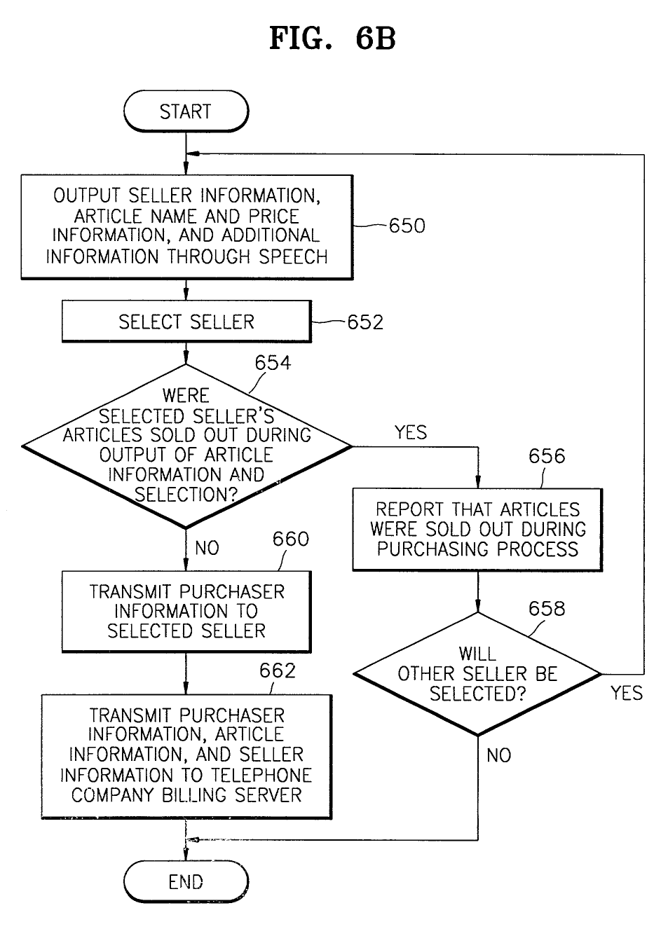

The following description with reference to FIG. 6A concerns a process of retrieving articles. FIG. 6A is a flowchart of an example of a process of retrieving article information in a telephone shopping mall server according to the embodiment of the present invention.

Once purchasing conditions are input in step 600, a database is primarily searched using the name of an article in step 602. In step 604, a list is created from the result of search. When it is determined that no items are retrieved in step 606, no items is reported in step 608. When it is determined that there is any retrieved item in step 606, it is determined whether there is any item meeting a price condition in step 610. Here, the price condition is determined by the range of a price in consideration of a predetermined tolerance on the basis of the price offered by a purchaser. When it is determined that there are no items meeting the price condition, no items is reported in step 608. In contrast, when it is determined that there is any item meeting the price condition, a list including seller information, the name and price of an article, and additional information is created 612. This list is reported to the purchaser.

A process of selecting a seller will be described below with reference to FIG. 6B. FIG. 6B is a flowchart of an example of a process of selecting a seller from article information retrieved in a telephone shopping mall server according to the embodiment of the present invention.

In step 650, a telephone shopping mall server outputs seller information, article name and price information, and additional information through speech. Once a purchaser selects a seller in step 652, it is determined whether the seller s articles were sold out in step 654. When the articles were sold out during a purchasing process, this fact is reported to the purchaser in step 656, and the purchaser is asked whether to select other seller in step 658. When the purchaser wishes to select other seller, step 650 and following steps are repeated.

When it is determined that the articles were not sold out during the purchasing process in step 654, a transaction is arranged and purchaser information is transmitted to the selected seller in step 660. In step 662, the purchase information, article information and seller information is transmitted to a telephone company billing server to request billing and payment of a purchase charge through a telephone charge.

The present invention can provide a safe and convenience telephone shopping service by using a purchaser s originator telephone number and a temporary password. In other words, in a conventional telephone shopping method, a purchaser needs to register a purchaser ID and password for purchaser authentication in advance and memorize them. In the present invention, an originator telephone number is used as a purchaser ID, and a temporary password which is valid for only a single transaction is instantly created by a purchaser so that the identity of the purchaser can be confirmed using the temporary password. Moreover, instead of using purchaser authentication information which is registered in advance and fixed if it is not modified specially, authentication information that is valid for only a single transaction is used in the present invention, thereby achieving high security.

In a conventional telephone shopping method, an additional device is necessary for processing settlement using a credit card or the like. However, in the present invention, a purchase charge is billed as a telephone charge so that a telephone shopping mall server does not need to be provided with an additional device for settling payment.

In addition, in a conventional telephone shopping method, a purchaser needs to be continuously on the telephone since accessing a telephone shopping mall and until articles meeting purchasing conditions are retrieved and a purchasing process is completed. In contrast, according to the present invention, a purchaser hangs up the telephone after accessing a telephone shopping mall and inputting simple purchaser authentication information and purchasing conditions. Then, the telephone shopping mall calls back the purchaser after completing the retrieval of articles meeting the purchasing conditions. Therefore, from the purchaser's viewpoint, waiting time and a telephone charge can be reduced.

While this invention has been particularly shown and described with reference to preferred embodiments thereof, it will be understood by those skilled in the art that various changes in forms and details may be made therein without departing from the spirit and scope of the invention. The above embodiments have been used in a descriptive sense only and not for purpose of limitation. Therefore, the scope of the invention will be defined by the appended claims not by the above description, and it should be construed that modifications made within the scope of the invention are covered by the present invention.

What is claimed is:

1. A method of providing an on-line shopping service through a telephone network, the method comprising the steps of:
(a) receiving a temporary password and purchasing conditions from a user through telephone connection;
(b) retrieving article information meeting the purchasing conditions received in step (a), after ending the telephone connection;
(c) setting telephone connection to the user using the user s originator telephone number and confirming the user using the temporary password received in step (a); and
(d) providing the article information retrieved in step (b) and arranging a transaction according to the user s selection.

2. The method of claim 1, wherein step (a) comprises the steps of:
(a1) receiving the originator telephone number of the user performing access through a telephone;
(a2) requesting the user to create the temporary password and receiving the temporary password from the user; and
(a3) requesting the user to input the purchasing conditions and receiving the purchasing conditions including at least article name and price information.

3. The method of claim 2, wherein in step (a1), the originator telephone number is automatically transmitted during telephone connection.

4. The method of claim 2, wherein step (a) further comprises the step of (a4) outputting the purchasing conditions received in step (a3) in the form of speech using a technique of outputting text in the form of speech to confirm the purchasing conditions.

5. The method of claim 1, wherein step (c) comprises the steps of:
(c1) setting telephone connection to the user using the originator telephone number;
(c2) requesting the user to input a temporary password to confirm the user s identity and receiving the temporary password from the user; and
(c3) comparing the temporary password received in step (a) with the temporary password received in step (c2) to confirm the user.

6. The method of claim 1, wherein step (d) comprises the steps of:
(d1) providing the article information retrieved in step (b) to the user through a telephone;
(d2) requesting the user to select a seller from the article information provided in step (d1) and receiving seller information selected by the user; and
(d3) confirming content received in step (d2) and arranging a transaction.

7. The method of claim 6, wherein in step (d1), the article information retrieved in step (b) is output in the form of speech using a technique of outputting text in the form of speech.

8. The method of claim 6, wherein step (d) further comprises the step of (d4) providing the details of the transaction arranged in step (d3) to the seller selected by the user.

9. A method of providing an on-line shopping service through a telephone network, the method comprising the steps of:
(a) receiving a temporary password and purchasing conditions from a user through telephone connection;
(b) retrieving article information meeting the purchasing conditions received in step (a), after ending the telephone connection;
(c) setting telephone connection to the user using the user s originator telephone number and confirming the user using the temporary password received in step (a);
(d) providing the article information retrieved in step (b) to the user through a telephone; and
(e) requesting a telephone company billing server to bill a purchase charge as a telephone charge when a transaction is arranged according to the user s selection.

10. The method of claim 9, wherein step (a) further comprises the step of (a1) outputting the purchasing conditions received from the user in the form of speech using a technique of outputting text in the form of speech to confirm the purchasing conditions.

11. The method of claim 9, wherein in step (d), the article information retrieved in step (b) is output in the form of speech using a technique of outputting text in the form of speech.

12. The method of claim 9, wherein step (e) further comprises the step of (e1) providing the details of the transaction to the seller selected by the user when the transaction is arranged according to the user s selection.

13. A system for providing an on-line shopping service, comprising:
a telephone network connector for interfacing with a user through a telephone network;
a database for storing user information and article information; and
a telephone shopping service processor for retrieving data from the database, storing data in the database, and processing a telephone shopping service request received from the user through the telephone network connector,
wherein the telephone shopping service processor receives a temporary password and purchasing conditions from the user through the telephone network connector, stores them in the database, retrieves article information meeting the purchasing conditions from the database after telephone connection to the user ends, sets telephone connection to the user through the telephone network connector using the user s originator telephone number when the retrieval of article information is completed, provides the retrieved article information to the user through the telephone network connector when the user is confirmed using the temporary password, and arranges a transaction according to the user s selection.

14. The system of claim 13, wherein the telephone shopping mall service processor provides the details of the transaction to a seller corresponding to the user s selection when the transaction is arranged according to the user s selection.

15. The system of claim 13, wherein the telephone shopping mall service processor requests a telephone company billing server to bill a purchase charge as a telephone charge when the transaction is arranged according to the user s selection.

16. The system of claim 13, further comprising a text-to-speech processor for outputting text in the form of speech, the text-to-speech processor providing the user with speech output for confirming the purchasing conditions received from the user and speech output for reporting the retrieved article information through the telephone network connector at the request of the telephone shopping service processor.

17. The system of claim 14, further comprising a text-to-speech processor for outputting text in the form of speech, the text-to-speech processor providing the user with speech output for confirming the purchasing conditions received from the user and speech output for reporting the retrieved article information through the telephone network connector at the request of the telephone shopping service processor.

18. The system of claim 15, further comprising a text-to-speech processor for outputting text in the form of speech, the text-to-speech processor providing the user with speech output for confirming the purchasing conditions received from the user and speech output for reporting the retrieved article information through the telephone network connector at the request of the telephone shopping service processor.
